(19) United States
(12) Patent Application Publication
(10) Pub. No.: US 2014/0213428 A1
(43) Pub. Date: Jul. 31, 2014

(54) PROCESS FOR STRIPPING AND A FLUID CATALYTIC CRACKING APPARATUS RELATING THERETO

(71) Applicant: UOP LLC, Des Plaines, IL (US)

(72) Inventors: Brian W. Hedrick, Oregon, IL (US); Paolo Palmas, Des Plaines, IL (US)

(73) Assignee: UOP LLC, Des Plaines, IL (US)

(21) Appl. No.: 13/751,454

(22) Filed: Jan. 28, 2013

(51) Int. Cl. B01J 8/00; B01J 38/00

(52) U.S. Cl. CPC B01J 8/0085; B01J 38/00
USPC 502/20; 422/285

(57) ABSTRACT

One exemplary embodiment can be a process for stripping. The process can include passing catalyst to a stripping vessel containing a riser, providing a plurality of baffles having a first baffle and a second baffle, and providing one or more packing layers. The stripping vessel and riser may define an annular zone including annular area for stripping of the catalyst, and the first and second baffles collectively overlap in no more than about 50% of the annular area. Often, the first baffle is coupled to an outer circumference of the riser and extends outward, and the second baffle is coupled to an inner circumference of the stripping vessel and extends inward. Typically, the one or more packing layers are within the annular zone.

### FIELD OF THE INVENTION

This invention generally relates to a process for stripping in, e.g., a fluid catalytic cracking apparatus.

### DESCRIPTION OF THE RELATED ART

Fluid catalytic cracking (which may be abbreviated as “FCC” herein) can be a catalytic conversion process for cracking heavy hydrocarbons into lighter hydrocarbons by bringing the heavy hydrocarbons into contact with a catalyst composed of finely divided particulate material in a fluidized reaction zone. Most FCC units use a zeolite-containing catalyst having high activity and selectivity. As the cracking reaction proceeds, substantial amounts of highly carbonaceous material, referred to as coke, may be deposited on the catalyst forming spent catalyst. Generally, a high temperature regeneration burns the coke from the spent catalyst. The regenerated catalyst may be cooled before being returned to the reaction zone. Typically, spent catalyst is continually removed from the reaction zone and replaced by essentially coke-free catalyst from the regeneration zone.

Often, the basic components of the FCC process include a riser, a reaction vessel, and a regenerator. In the riser, a distributor may inject a hydrocarbon feed that can contact the catalyst and be cracked into lighter hydrocarbons. A lift gas may be used to accelerate catalyst in a lower section of the riser below or during introduction of the feed. The lift velocity can refer to the velocity of the gas and the lifted catalyst just before feed distribution into the riser. Catalyst and hydrocarbon feed may be transported upward in the riser by the expansion of the gases that may result from the vaporization of the hydrocarbons. Often, coke accumulates on the catalyst particles as a result of the cracking reaction. The reaction vessel may disengage spent catalyst from product vapors. A catalyst stripper can remove adsorbed hydrocarbons from the surface of the catalyst. Generally, the regenerator burns the coke from the catalyst and recycles the regenerated catalyst into the riser.

Generally, many catalyst strippers include a support grid and steam distribution system that restricts the catalyst flow causing a conflict in flow patterns between the upward flowing steam and downward flowing catalyst. Such flow restricted areas can tend to accumulate gas that may coalesce into large bubbles further restricting the flow of gas and catalyst. Often, the current support grid occupies up to 40% of the cross-sectional area and the distribution grid occupies up to 60% of the cross-sectional area. Moreover, trays within the stripping vessel can overlap permitting mostly micro-distribution of fluid. Thus, it would be desirable to minimize the support grid and system cross-sectional area to not unduly restrict flow.

### SUMMARY OF THE INVENTION

One exemplary embodiment can be a process for stripping. The process can include passing catalyst to a stripping vessel containing a riser, providing a plurality of baffles having a first baffle and a second baffle, and providing one or more packing layers. The stripping vessel and riser may define an annular zone including annular area for stripping of the catalyst, and the first and second baffles collectively overlap in no more than about 50% of the annular area. Often, the first baffle is coupled to an outer circumference of the riser and extends outward, and the second baffle is coupled to an inner circumference of the stripping vessel and extends inward. Typically, the one or more packing layers are within the annular zone.

Another exemplary embodiment can be a fluid catalytic cracking apparatus. The fluid catalytic cracking apparatus can include a stripping vessel forming an inner circumference, a riser received within the stripping vessel and forming an outer circumference, one or more packing layers, and a plurality of baffles having a first baffle and a second baffle. The inner circumference and the outer circumference may define an annular zone. The one or more layers can be positioned within the annular zone and the first and second baffles of the plurality of baffles can be positioned below the one or more packing layers.

A further exemplary embodiment may be a process for stripping. The process can include passing catalyst to a stripping vessel, providing a plurality of baffles including a first baffle and a second baffle, and providing one more packing layers above the plurality of baffles. The stripping vessel may form an interior area defined by an inner circumference of the stripping vessel. Often, the first baffle is positioned within the stripping vessel spaced apart from the inner circumference, and the second baffle is coupled to the inner circumference and extends inward into the interior area.

In the embodiments disclosed herein, providing macro-distribution of fluid flow lessens gas velocity downward and improves the performance of a fluid catalytic cracking apparatus. Particularly, the stripping vessel can have baffles spaced apart that allow the macro-distribution of fluid flow.

### DEFINITIONS

As used herein, the term “zone” can refer to an area including one or more equipment items and/or one or more sub-zones. Equipment items can include one or more reactors or reactor vessels, heaters, exchangers, pipes, pumps, compressors, and controllers. Additionally, an equipment item, such as a reactor, dryer, or vessel, can further include one or more zones or sub-zones.

As used herein, the term “coupled” can mean two items, directly or indirectly, joined, fastened, associated, connected, or formed integrally together either by chemical or mechanical means, by processes including stamping, molding, or welding. What is more, two items can be coupled by the use of a third component such as a mechanical fastener, e.g., a screw, a nail, a staple, or a rivet; an adhesive; or a solder.

As used herein, the term “macro-distribution” can mean main currents of fluid typically flowing up or down in a stripping vessel as opposed to micro-distribution of fluid usually having a smaller volume than macro-distribution and in different directions than up or down in a stripping vessel. Micro-distribution can include currents such as eddies, swirls, and vortexes.

### BRIEF DESCRIPTION OF THE DRAWINGS

FIG. 1 is a cross-sectional schematic depiction of an exemplary apparatus.

FIG. 2 is a cross-sectional depiction along line 2-2 of FIG. 1 of the exemplary apparatus.

FIG. 3 is a cross-sectional schematic depiction of another version of the exemplary apparatus.

FIG. 4 is a cross-sectional depiction along line 4-4 of FIG. 3 of the another version of the exemplary apparatus.

### DETAILED DESCRIPTION

An FCC apparatus may be used in an FCC process. Such an exemplary FCC apparatus and process are disclosed in, e.g., U.S. Ser. No. 13/492,025. The FCC apparatus can include a regenerator and a riser-reactor. The riser-reactor may include a reaction separation vessel, a stripping zone, and a riser. Generally, the feed can have a boiling point range of about 180-about 800° C. The feed can be at least one of a gas oil, a vacuum gas oil, an atmospheric gas oil, an atmospheric residue, and a vacuum residue. Alternatively, the feed may be at least one of a heavy cycle oil and a slurry oil. The feed may have a temperature of about 140-about 430° C., preferably about 200-about 290° C.

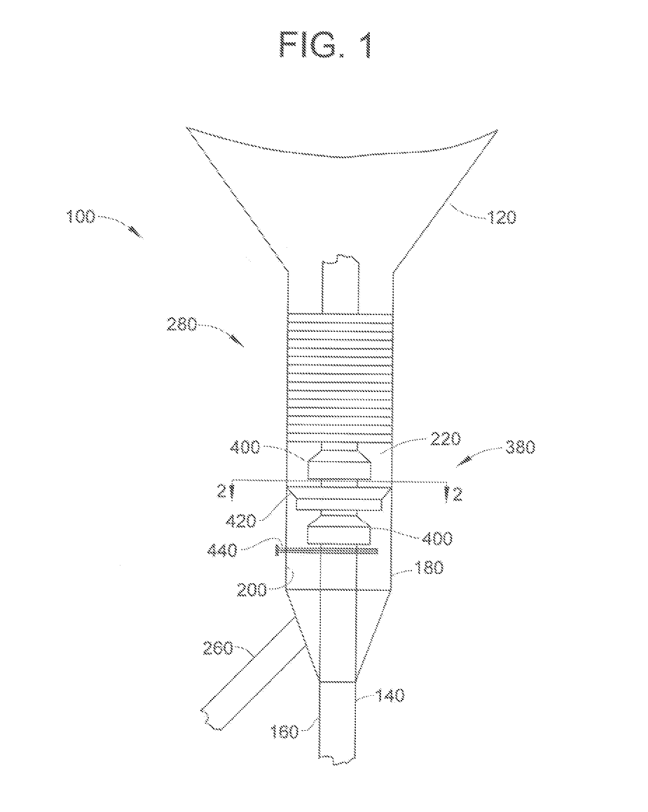

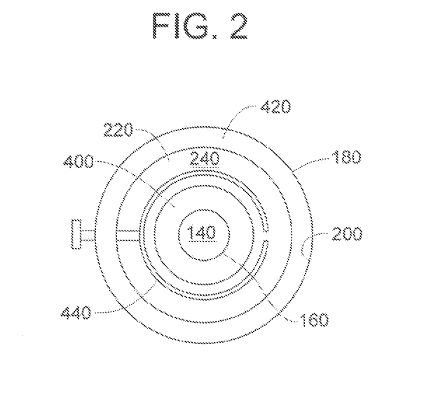

Referring to FIGS. 1-2, only a portion of the riser-reactor of an apparatus 100 is depicted, namely a riser 140, partially depicted, for providing the feed and catalyst to a reaction separation vessel 120, partially depicted, and a stripping vessel 180 at least partially or completely surrounding the riser 140 near its top. The stripping vessel 180 can receive catalyst from the reaction separation vessel 120 separated from a hydrocarbon product. The fallen catalyst may be stripped with steam provided by a steam ring 440 prior to regeneration.

The riser 140 may form an outer circumference 160 and the stripping vessel 180 can form an inner circumference 200. One or more packing layers 280, which in this exemplary embodiment can be sixteen layers, may surround the riser 140 inside the stripping vessel 180. Additionally, a plurality of baffles 380 including a first baffle or ring 400 and a second baffle or ring 420 can at least partially or completely surround the riser 140 and form respective rings. The first baffle 400 may form a conical frustum-shaped ring and be coupled to the outer circumference 160 of the riser 140. The second baffle 420 may form an inverted conical frustum-shaped ring and be coupled to the inner circumference 200 of the stripping vessel 180. In this exemplary embodiment, two first baffles 400 are depicted above or below the second baffle 420, although any suitable number of baffles 400 and 420 may be utilized.

The steam ring 440 can be positioned underneath the plurality of baffles 380. A spent catalyst standpipe 260 can remove stripped catalyst from the riser-reactor to the regenerator, as disclosed in, e.g., U.S. Pat. No. 5,451,313.

Referring to FIG. 2, the outer circumference 160 of the riser 140 and the inner circumference 200 of the stripping vessel 180 may form an annular or stripping zone 220. The annular zone 220 can include a cross-sectional, horizontal slice, namely an annular area 240. The annular area 240 may be a horizontal slice defined by the outer circumference 160 of the riser 140 and the inner circumference 200 of the stripping vessel 180. Multiple annular areas may be stacked within the annular zone 220. The first baffle 400 can extend from the outer circumference 160 of the riser 140, and the second baffle 420 can extend from the inner circumference 200 of the stripping vessel 180. Thus, the first baffle 400 and the second baffle 420, as well as the steam ring 440, can overlap into the annular area 240, as viewed from above. Although the baffles 400 and 420 are at different elevations, these baffles 400 and 420 can at least partially overlap or intersect the annular area 240. In some exemplary embodiments, the first baffle 400 and the second baffle 420 overlap no more than about 20-no more than about 50%, about 20-about 40%, about 30-about 40%, and about 30-no more than about 50% of the annular area 240. Desirably, the baffles 400 and 420 may be modified to overlap only about 25-about 33% of the annular area 240. However, typically a gap is created between the baffles 400 and 420. During servicing of the stripping vessel 180, the riser 140 with attached baffles 400 can be removed without detaching the second baffle 420 from the stripping vessel 180. In some instances, the clearance between the baffles 400 and 420 can be as low as about 0.02-about 0.05 meter.

This increased spacing can improve the macro-distribution of fluid flow. Moreover, one or more packing layers 280 can have sixteen layers, which can be reduced from, e.g., twenty or thirty layers. Additionally, one or more packing layers may be further reduced from sixteen layers to ten or even five layers to improve macro-distribution of fluid flow through the annular zone 220. Usually, a support grid is provided and its area set by the load calculation of the packing. Reducing the load of the packing may reduce restriction and obstruction by the support grid.

Generally, the steam can be provided by a steam ring 440 underneath the first and second baffles 400 and 420. Utilizing a steam ring 440 instead of, e.g., a steam grid or a ring with branches, can minimize obstruction, particularly if fewer jets are provided with each jet providing more gas. Thus, gas can be provided to a larger volume per jet. Thus, the steam ring 440 may reduce the overlap with the annular area 240 to less than about 25% while macro-distributing the steam to the stripping zone 220 above. Thus, the downward velocity of the catalyst may be reduced, as well as the tendency of catalyst to drag steam and other gases downward.

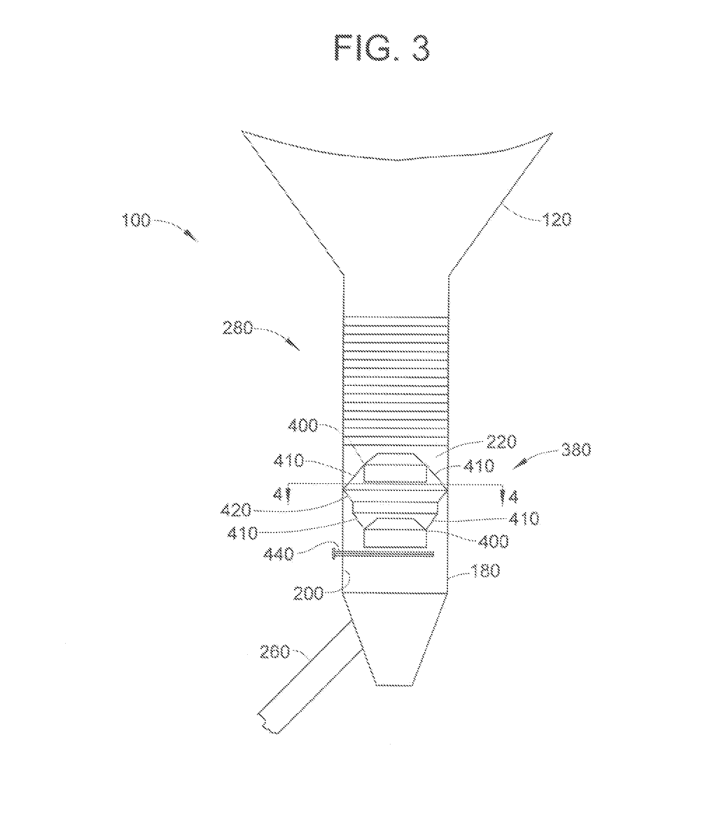

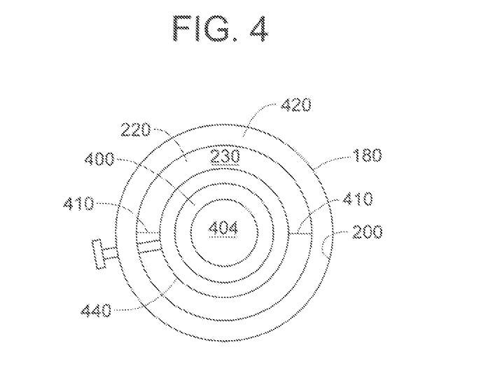

Referring to FIGS. 3-4, another version of the exemplary apparatus 100 is depicted. This version can be substantially similar to the exemplary apparatus 100 discussed above, except the riser 140 is omitted. Instead, the second baffle 420 is coupled to the inner circumference 200 of the stripping vessel 180 with the first baffle 400 spaced apart from the inner circumference 200. Each of the first baffles 400 can be coupled to the second baffle 420 via supports 410 and form a circular cap 404. Alternatively, the first baffles 400 can have a ring surrounding a respective circular plate. The inner circumference 200 of the stripping vessel 180 can contain the stripping zone 220, which in turn may define an interior area 230. The interior area 230 can be a horizontal slice that may be substantially circular-shaped, but may be intersected or overlapped by the baffles 400 and/or 420 and optionally the steam ring 440. Although one interior area 230 is depicted, multiple areas may be stacked within the stripping zone 220. Steam can be provided to the steam ring 440 and the baffles 400 and 420 can provide macro-distribution of steam. Again, sixteen packing layers are depicted, but any suitable number of packing layers may be utilized. In this exemplary embodiment, the first baffle 400 and the second baffle 420 overlap no more than about 20-no more than about 50%, about 20-about 40%, about 30%-about 40%, and about 30-no more than about 50% of the interior area 230.

In one exemplary embodiment, installing the plurality of baffles 380 below the one or more packing layers 280 can enable distribution of the steam thereto with a relatively simple steam ring 440 instead of a relatively more complex pipe grid. Additionally, the plurality of baffles 380 can distribute the steam over the cross-section of the stripping section before the steam ascends to the one or more packing layers 280 and achieve steam distribution below the one or more packing layers 280 when the less complex steam distributor is used rather than using more complex mechanisms for distributing steam in the packing.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing, all temperatures are set forth in degrees Celsius, unless otherwise indicated.

From the foregoing description, one skilled in the art can easily ascertain the essential characteristics of this invention and, without departing from the spirit and scope thereof, can make various changes and modifications of the invention to adapt it to various usages and conditions.

1. A process for stripping, comprising:
A) passing catalyst to a stripping vessel wherein the stripping vessel contains a riser wherein the stripping vessel and riser define an annular zone comprising an annular area for stripping of catalyst;
B) providing a plurality of baffles comprising a first baffle and a second baffle wherein the first baffle is coupled to an outer circumference of the riser and extends outward and the second baffle is coupled to an inner circumference of the stripping vessel and extends inward, wherein the first and second baffles collectively overlap in no more than about 50% of the annular area; and
C) providing one or more packing layers within the annular zone.

2. The process according to claim 1, wherein the first and second baffles overlap in about 20-no more than about 50% of the annular area.

3. The process according to claim 1, wherein the first and second baffles overlap in about 20-about 40% of the annular area.

4. The process according to claim 1, wherein the first and second baffles overlap in about 30-no more than about 50% of the annular area.

5. The process according to claim 1, wherein the first baffle and second baffle form respective rings.

6. The process according to claim 1, wherein the first baffle forms a conical frustum-shaped ring and the second baffle forms an inverted conical frustum-shaped ring.

7. The process according to claim 1, wherein the stripping vessel and riser define an annular zone containing the annular area.

8. The process according to claim 7, wherein the plurality of baffles is positioned within the annular zone.

9. The process according to claim 8, wherein the one or more packing layers is positioned above the plurality of baffles.

10. The process according to claim 9, further comprising reducing the packing layers to provide improved macro-distribution of fluid.

11. The process according to claim 9, further comprising providing a steam ring under the plurality of baffles.

12. A fluid catalytic cracking apparatus, comprising:
A) a stripping vessel forming an inner circumference;
B) a riser received within the stripping vessel and forming an outer circumference wherein the inner circumference and the outer circumference define an annular zone;
C) one or more packing layers positioned within the annular zone; and
D) a plurality of baffles, comprising a first baffle and a second baffle positioned below the one or more packing layers.

13. The fluid catalytic cracking apparatus according to claim 12, wherein annular zone comprises an annular area, and the first and second baffles overlap in about 20-no more than about 50% of the annular area.

14. The fluid catalytic cracking apparatus according to claim 13, wherein the first and second baffles overlap in about 20-about 40% of the annular area.

15. The fluid catalytic cracking apparatus according to claim 13, wherein the first and second baffles overlap in about 30-no more than about 50% of the annular area.

16. The fluid catalytic cracking apparatus according to claim 12, further comprising a steam ring under the plurality of baffles.

17. The fluid catalytic cracking apparatus according to claim 16, wherein the one or more packing layers comprise no more than about sixteen packing layers.

18. The fluid catalytic cracking apparatus according to claim 12, wherein the first baffle and second baffle form respective rings.

19. The fluid catalytic cracking apparatus according to claim 18, wherein the first baffle forms a conical frustum-shaped ring and the second baffle forms an inverted conical frustum-shaped ring.

20. A process for stripping, comprising:
A) passing catalyst to a stripping vessel wherein the stripping vessel forms an interior area defined by an inner circumference of the stripping vessel;
B) providing a plurality of baffles comprising a first baffle and a second baffle wherein the first baffle is positioned within the stripping vessel spaced apart from the inner circumference and the second baffle is coupled to the inner circumference and extends inward into the interior area; and
C) providing one or more packing layers above the plurality of baffles.
